(19) United States
(12) Patent Application Publication
(10) Pub. No.: US 2017/0133722 A1
(43) Pub. Date: May 11, 2017

(54) BATTERY APPARATUS FOR VEHICLE

(71) Applicant: Hyundai Motor Company, Seoul (KR)

(72) Inventors: Dal Kim, Yongin (KR); Beom Gyu Kim, Suwon (KR); Yoon Cheol Jeon, Suwon (KR); Suk Hyung Kim, Gunpo (KR); Jin Ho Park, Seoul (KR)

(21) Appl. No.: 15/138,983

(22) Filed: Apr. 26, 2016

(30) Foreign Application Priority Data
Nov. 5, 2015 (KR) 10-2015-0155371

(51) Int. Cl. H01M 10/42; H01M 10/6556; H01M 10/613; H01M 10/625; B60L 11/18; H01M 2/10

(52) U.S. Cl. CPC H01M 10/425; B60L 11/1877; H01M 2/1077; H01M 2/1083; H01M 10/613; H01M 10/625; H01M 10/6556; H01M 2220/20; H01M 2010/4271

(57) ABSTRACT

A battery apparatus for a vehicle is provided. The apparatus includes a basic battery pack that is mounted within the vehicle and an auxiliary battery pack that is selectively mountable within the vehicle. The auxiliary battery pack is connected in series with or in parallel to the basic battery pack.

### CROSS-REFERENCE TO RELATED APPLICATION

This application is based on and claims the benefit of priority to Korean Patent Application No. 10-2015-0155371, filed on Nov. 5, 2015 in the Korean Intellectual Property Office, the disclosure of which is incorporated herein in its entirety by reference.

### TECHNICAL YIELD

The present disclosure relates to a battery apparatus for a vehicle, and more particularly, to a battery apparatus for a vehicle that increases an all-electric range (AER) that the vehicle may travel using a battery.

### BACKGROUND

A battery for driving a motor is installed in eco-friendly vehicles such as electric vehicles, hybrid vehicles, and the like. A plug-in hybrid vehicle (PHEV) among the hybrid vehicles, which is a rechargeable hybrid vehicle such as the electric vehicle, is an alternative vehicle that utilizes an infrastructure limit of the electric vehicle and an infrastructure of an internal combustion engine vehicle. Since the plug-in hybrid vehicle may have driving stability and use inexpensive electricity when being driven in an EV mode, the consumers may require an increase in an all electric range (hereinafter, referred to as ‘AER’), and the increase in the AER is actively being researched and developed.

In general, research shows that a day's average movement distance of the vehicle is about 40 to 60 km. Further, it may be undesirable to increase weight (about 100 kg) of the battery caused by additionally mounting the battery to increase the AER. For example, not all consumers may require the increase in the AER. Accordingly, a method for allowing the consumers to optimally select the mounting of the additional battery by mounting the additional battery in an existing battery mounted within vehicle has been demanded.

### SUMMARY

The present disclosure provides a battery apparatus for a vehicle capable of effectively implementing a partial option of a battery by additionally (selectively) mounting an auxiliary battery in a basic battery mounted in an existing vehicle, and capable of selecting an increase function of an all electric range (AER) based on a user selection.

According to an exemplary embodiment of the present disclosure, a battery apparatus for a vehicle may include a basic battery pack configured to be mounted within the vehicle; and an auxiliary battery pack configured to be selectively mountable in the vehicle, wherein the auxiliary battery pack may be connected in series with or in parallel to the basic battery pack. A cooling line through which a cooling fluid is circulated may be connected to each of the basic battery pack and the auxiliary battery pack.

Further, each of the basic battery pack and the auxiliary battery pack may include a plurality of cells, and the basic battery pack may be installed with a battery management unit configured to manage the basic battery pack and the auxiliary battery pack. Each of the basic battery pack and the auxiliary battery pack may be installed with a cell management unit configured to separately manage a plurality of cells.

According to another exemplary embodiment of the present disclosure, a battery apparatus for a vehicle may include a basic battery pack configured to be mounted within the vehicle; and an auxiliary battery pack configured to be selectively mountable within the vehicle, wherein the auxiliary battery pack may be connected in series with the basic battery pack, each of the basic battery pack and the auxiliary battery pack may include a plurality of modules connected in series, the module may include a plurality of sub-modules connected in series, and the sub-module may include two or more cells connected in parallel. A fuse may be installed between the module and the module. The auxiliary battery pack may be installed with a safety switch. Additionally, the auxiliary battery pack may be connected in series with the basic battery pack through a junction box.

According to another exemplary embodiment of the present disclosure, a battery apparatus for a vehicle may include a basic battery pack mounted within the vehicle; an auxiliary battery pack configured to be selectively mountable within the vehicle and be connected in parallel to the basic battery pack; and a power relay assembly configured to be installed in the basic battery pack, have a plurality of relays, and be switched to supply operation power of the basic battery pack to a load side based on whether the plurality of relays are operated.

The battery apparatus may further include a bi-directional power converter installed in the auxiliary battery pack and configured to balance a voltage level between the basic battery pack and the auxiliary battery pack. The basic battery pack and the auxiliary battery pack may be discharged while maintaining the balancing for the voltage level therebetween by the bi-directional power converter. The battery apparatus may further include an auxiliary power relay assembly installed in the auxiliary battery pack and including one or more auxiliary relays. The auxiliary relay may be a latch relay.

The battery apparatus may further include an auxiliary power relay assembly installed in the auxiliary battery pack, having a plurality of auxiliary relays, and which may be switched to supply operation power of the auxiliary battery pack to the load side based on whether the plurality of relays are operated, wherein the relays of the power relay assembly and the auxiliary relays of the auxiliary power relay assembly may be separately connected through connection lines.

### BRIEF DESCRIPTION OF THE DRAWINGS

The above and other objects, features and advantages of the present disclosure will be more apparent from the following detailed description taken in conjunction with the accompanying drawings

FIG. 1 is a diagram illustrating a battery apparatus for a vehicle according to a first exemplary embodiment of the present disclosure;

FIG. 2 is a diagram illustrating a battery apparatus for a vehicle according to a second exemplary embodiment of the present disclosure;

FIG. 3 is a diagram illustrating a battery apparatus for a vehicle according to a third exemplary embodiment of the present disclosure; and

FIG. 4 is a diagram illustrating a battery apparatus for a vehicle according to a fourth exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referral to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings. For reference, sizes of components, thicknesses of lines, and the like which are shown in the drawings referenced for describing the present disclosure may be slightly exaggerated for convenience of understand. Further, since the terminologies used to describe the present disclosure are defined in consideration of the functions in the present disclosure, they may be construed in different ways depending on a user, an intention of an operator, practices, and the like. Therefore, the definition of the terminologies should be construed based on the contents throughout the specification.

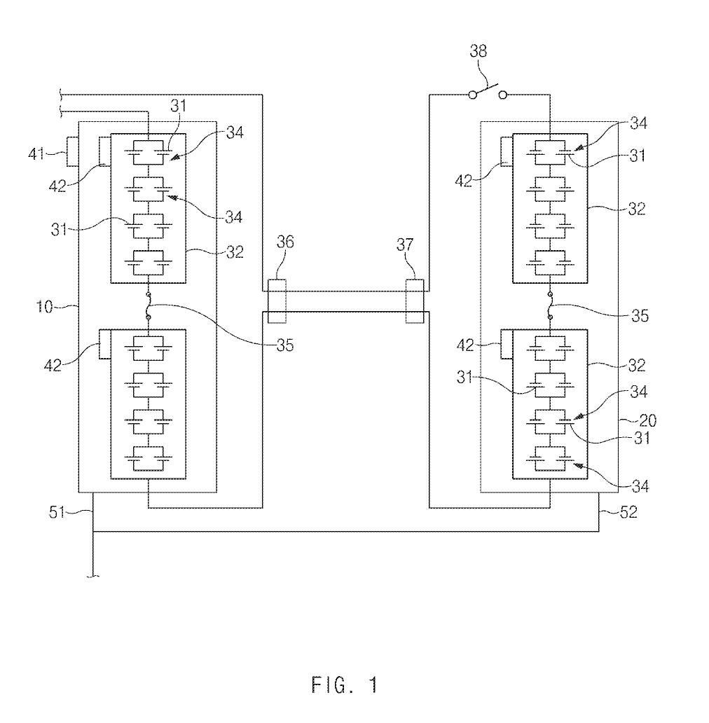

FIG. 1 is a diagram illustrating a battery apparatus for a vehicle according to a first exemplary embodiment of the present disclosure. Referring to FIG. 1, the battery apparatus for a vehicle according to the present disclosure may include a basic battery pack 10 mounted within the vehicle and an auxiliary battery pack 20 selectively (e.g., optionally) mountable within the vehicle.

The basic battery pack 10 may include a plurality of cells 31, and the plurality of cells 31 may be connected in various schemes such as a series scheme, a parallel scheme, a series/parallel scheme, and the like. Additionally, the basic battery pack 10 may include a battery management unit 41 configured to monitor and manage the basic battery pack 10 and the auxiliary battery pack 20. A first cooling line 51 may be connected to the basic battery pack 10, and the first cooling line 51 may be configured to circulate a cooling fluid (e.g., a coolant) through a cooling passage formed in a housing of the basic battery pack 10. Accordingly, an appropriate cooling for the basic battery pack 10 may be performed to prevent overheating of the battery.

The auxiliary battery pack 20 may include a plurality of cells 31, and may be configured in a selectively or additionally mountable structure as an option of the vehicle. The auxiliary battery pack 20 may be connected in series with or in parallel to the basic battery pack 10. Accordingly, the auxiliary battery pack 20 may be additionally connected to the basic battery pack 10, to thus increase electric energy of the vehicle and increase an all-electric range (AER) of the vehicle. A second cooling line 52 may be connected to the auxiliary battery pack 20, and the second cooling line 52 may be configured to circulate a cooling fluid through a cooling passage formed in a housing of the auxiliary battery pack 20. Thus, an appropriate cooling for the auxiliary battery pack 20 may be performed.

According to the exemplary embodiment of FIG. 1, the auxiliary battery pack 20 may be connected in series with the basic battery pack 10. As illustrated in FIG. 1, each of the basic battery pack 10 and the auxiliary battery pack 20 may include a plurality of modules 32 connected in series, and each of the plurality of modules 32 may include a plurality of sub-modules 34 connected in series. In addition, each of the sub-modules 34 may include two or more cells 31 connected in parallel. A fuse 35 configured to prevent an electric overload may be installed between the module 32 and the module 32.

Further, each of the modules 32 may be individually installed with a cell management unit 42 configured to monitor and manage each of the cells 31. The cell management unit 42 may be operated by a controller. According to the present disclosure, the plurality of cells 31 configures the sub-modules 34 and the modules 32, to more effectively implement stability such as a general control and management of the battery, an over-voltage prevention, an improvement of discharging and charging efficiency, and the like. Particularly, since each of the sub-modules 34 may include two or more cells 31 connected in parallel, when the basic battery pack 10 and the auxiliary battery pack 20 are connected in series, an overload of a voltage may be prevented.

Meanwhile, the auxiliary battery pack 20 may be connected in series with the basic battery pack 10 via one or more junction boxes 36 and 37, to more simply and stably perform a connection of the auxiliary battery pack 20 to the basic battery pack 10 when additionally mounting the auxiliary battery pack 20. The junction boxes 36 and 37 may include a first junction box 36 disposed adjacent to the basic battery pack 10, and a second junction box 37 disposed adjacent to the auxiliary battery pack 20. The series connection between the basic battery pack 10 and the auxiliary battery pack 20 may be more stably performed by the first and second junction boxes 36 and 37. In addition, the auxiliary battery pack 20 may include a safety switch 38 configured to prevent leakage of a current, a short circuit, and the like when additionally mounting the auxiliary battery pack 20.

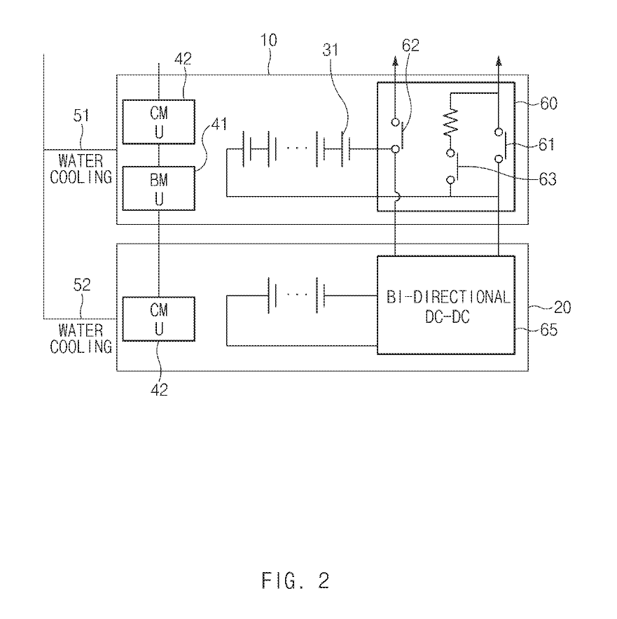

FIG. 2 is a diagram illustrating a battery apparatus for a vehicle according to a second exemplary embodiment of the present disclosure. Referring to FIG. 2, a battery apparatus for a vehicle according to a second exemplary embodiment of the present disclosure may include the basic battery pack 10 mounted within the vehicle, the auxiliary battery pack 20 connected in parallel to the basic battery pack 10, a power relay assembly 60 installed within the basic battery pack 10.

In particular, the power relay assembly 60 may be connected to the cell 31 of the basic battery pack 10 and may include a plurality of relays 61, 62, and 63. The plurality of relays 61, 62, and 63 may have a first main contact relay 61 connected to a positive electrode of the basic battery pack 10, a second main contact relay 62 connected to a negative electrode of the basic battery pack 10, and a pre-charge relay 63 connected in parallel to the first main contact relay 61.

Accordingly, the power relay assembly 60 may be switched to supply operation power of the basic battery pack 10 to a load side based on whether the relays 61, 62, and 63 are operated. Further, the auxiliary battery pack 20 may include a bi-directional power converter 65 such as a bi-direction direct current-direct current (DC-DC) converter, or the like. A voltage level between the basic battery pack 10 and the auxiliary battery pack 20 may be balanced using the bi-directional power converter 65. The auxiliary battery pack 20 may also be connected to the basic battery pack 10 at a lower voltage by the bi-directional power converter 65. Particularly, the basic battery pack 10 and the auxiliary battery pack 20 may be discharged while maintaining the balancing of a voltage level therebetween by the bi-directional power converter 65.

Meanwhile, when the bi-directional power converter 65 is configured as the bi-directional DC-DC converter, a discharge time of the basic battery pack 10 may be considered. In addition, since the basic battery pack 10 and the auxiliary battery pack 20 may be connected in parallel, the auxiliary battery pack 20 may be charged simultaneously with the basic battery pack 10. Additionally, each of the basic battery pack 10 and the auxiliary battery pack 20 according the second exemplary embodiment may be formed in a structure in which a plurality of cells 31 are connected in series.

Furthermore, each of the basic battery pack 10 and the auxiliary battery pack 20 according to the second exemplary embodiment may include a plurality of modules 32 connected in series, each of the plurality of modules 32 may include a plurality of sub-modules 34 connected in series, and each of the plurality of sub-modules 34 may include two or more cells 31 connected in parallel, similarly to the exemplary embodiment of FIG. 1. Other configurations may be implemented in similar to or the same structure as the exemplary embodiment of FIG. 1.

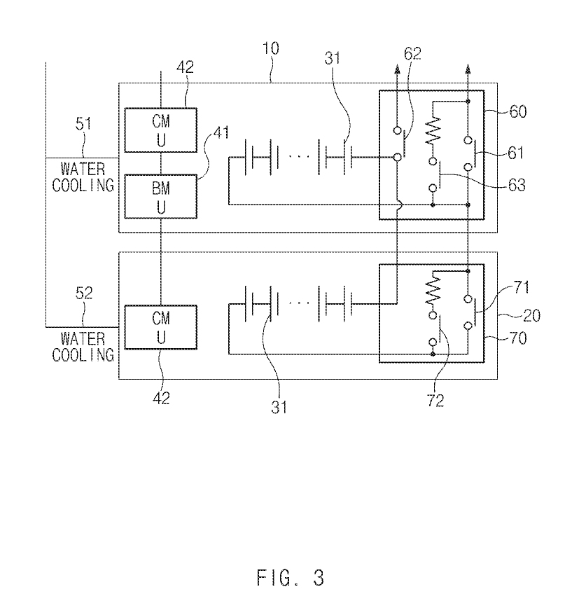

FIG. 3 is a diagram illustrating a battery apparatus for a vehicle according to a third exemplary embodiment of the present disclosure. Referring to FIG. 3, a battery apparatus for a vehicle according to a third exemplary embodiment of the present disclosure may include the basic battery pack 10 mounted within the vehicle, the auxiliary battery pack 20 connected in parallel to the basic battery pack 10, the power relay assembly 60 mounted within the basic battery pack 10, and an auxiliary power relay assembly 70 mounted within the auxiliary battery pack 20.

Particularly, the power relay assembly 60 may be connected to the cell 31 of the basic battery pack 10 and may include the plurality of relays 61, 62, and 63. The plurality of relays 61, 62, and 63 may have the first main contact relay 61 connected to the positive electrode of the basic battery pack 10, the second main contact relay 62 connected to the negative electrode of the basic battery pack 10, and the pre-charge relay 63 connected in parallel to the first main contact relay 61. Accordingly, the power relay assembly 60 may be switched to supply the operation power of the basic battery pack 10 to the load side based on whether the relays 61, 62, and 63 are operated.

The auxiliary battery pack 20 may further include the auxiliary power relay assembly 70, and the auxiliary power relay assembly 70 according to the exemplary embodiment of FIG. 3 may include an auxiliary relay 71 and a pre-charge relay 72. The auxiliary relay 71 may be connected to a positive electrode of the auxiliary battery pack 20. Particularly, a negative electrode of the auxiliary battery pack 20 may be directly connected to the negative electrode of the basic battery pack 10. The pre-charge relay 72 may be connected in parallel to the auxiliary relay 71. Accordingly, since the battery apparatus for a vehicle is configured in a structure in which the auxiliary power relay assembly 70 may be connected to the power relay assembly 60, the auxiliary battery pack 20 may be discharged simultaneously with the basic battery pack 10.

According to the third exemplary embodiment, the auxiliary relay 71 may be configured as a latch relay to thus minimize driving current of the relay. Since the basic battery pack 10 and the auxiliary battery pack 20 may be simultaneously discharged, an overall discharging efficiency may be increased. In addition, each of the basic battery pack 10 and the auxiliary battery pack 20 according to the third exemplary embodiment may be formed in a structure in which a plurality of cells 31 are connected in series.

Furthermore, each of the basic battery pack 10 and the auxiliary battery pack 20 according to the third exemplary embodiment may include a plurality of modules 32 connected in series, each of the plurality of modules 32 may include a plurality of sub-modules 34 connected in series, and each of the plurality of sub-modules 34 may include two or more cells 31 connected in parallel, similarly to the exemplary embodiment of FIG. 1. Other configurations may be implemented in similar to or the same structure as the exemplary embodiment of FIG. 1.

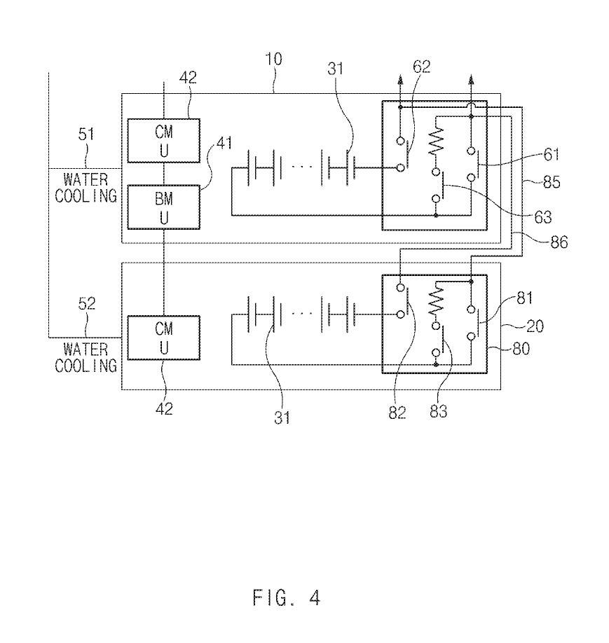

FIG. 4 is a diagram illustrating a battery apparatus for a vehicle according to a fourth exemplary embodiment of the present disclosure. Referring to FIG. 4, a battery apparatus for a vehicle according to a fourth exemplary embodiment of the present disclosure may include the basic battery pack 10 mounted within the vehicle, the auxiliary battery pack 20 connected in parallel to the basic battery pack 10, the power relay assembly 60 mounted within the basic battery pack 10, and the auxiliary power relay assembly 80 mounted within the auxiliary battery pack 20.

The power relay assembly 60 may be connected to the cell 31 of the basic battery pack 10 and may include the plurality of relays 61, 62, and 63. The plurality of relays 61, 62, and 63 may have the first main contact relay 61 connected to the positive electrode of the basic battery pack 10, the second main contact relay 62 connected to the negative electrode of the basic battery pack 10, and the pre-charge relay 63 connected in parallel to the first main contact relay 61. Accordingly, the power relay assembly 60 may be switched to supply the operation power of the basic battery pack 10 to the load side based on whether the relays 61, 62, and 63 are operated.

The auxiliary battery pack 20 may further include the auxiliary power relay assembly 80, and the auxiliary power relay assembly 80 according to the exemplary embodiment of FIG. 4 may include a first auxiliary relay 81 connected to the power relay assembly 60 via a first connection line 85, a second auxiliary relay 82 connected to the power relay assembly 60 via a second connection line 86, and a pre-charge relay 83 connected in parallel to the first auxiliary relay 81.

In particular, the first auxiliary relay 81 may be connected to the positive electrode of the auxiliary battery pack 20, and the first connection line 85 may be connected to the first auxiliary relay 81. The first connection line 85 may form a junction with the second main contact relay 62 of the power relay assembly 60. Accordingly, the first auxiliary relay 81 may be connected to the second main contact relay 62 of the power relay assembly 60 via the first connection line 85. The second auxiliary relay 82 may be connected to the negative electrode of the auxiliary battery pack 20, and the second connection line 86 may be connected to the second auxiliary relay 82. The second connection line 86 may form a junction with the first main contact relay 61 of the power relay assembly 60. Accordingly, the second auxiliary relay 82 may be connected to the first main contact relay 61 of the power relay assembly 60 via the second connection line 86.

Based on the configuration described above, the discharging and the charging of the basic battery pack 10 and the auxiliary battery pack 20 may also be sequentially performed while being changed by an operation of the power relay assembly 60 of the basic battery pack 10 and an operation of the auxiliary power relay assembly 80 of the auxiliary battery pack 20. For example, when the battery is discharged, the discharging of the basic battery pack 10 may first be performed, and the discharging of the auxiliary battery pack 20 may be performed thereafter. In addition, when the battery is charged, the charging of the basic battery pack 10 may first be performed, and the charging of the auxiliary battery pack 20 may be performed thereafter.

Further, when the discharging and the charging of the basic battery pack 10 and the auxiliary battery pack 20 are changed, an output map of the basic battery pack 10 and an output map of the auxiliary battery pack 20 may be separately operated based on driving, capacity, and the like of an engine. Each of the basic battery pack 10 and the auxiliary battery pack 20 according to the fourth exemplary embodiment may be formed in a structure in which a plurality of cells 31 are connected in series.

Moreover, each of the basic battery pack 10 and the auxiliary battery pack 20 according to the fourth exemplary embodiment may include a plurality of modules 32 connected in series, each of the plurality of modules 32 may include a plurality of sub-modules 34 connected in series, and each of the plurality of sub-modules 34 may include two or more cells 31 connected in parallel, similarly to the exemplary embodiment of FIG. 1. Other configurations may be implemented in similar to or the same structure as the exemplary embodiment of FIG. 1.

As described above, according to the exemplary embodiments of the present disclosure, the battery apparatus for a vehicle may effectively implement the partial option of the battery by additionally (selectively) mounting the auxiliary battery in the basic battery mounted in the existing vehicle, and may select the increase function of the AER based on the user selection of the additionally auxiliary battery. Particularly, a more stable electrical connection structure between the basic battery and the auxiliary battery may be effectively implemented, and the additional mounting of the auxiliary battery may be performed accordingly.

Hereinabove, while the exemplary embodiments of the present disclosure have been described, the present disclosure is not limited to the exemplary embodiments disclosed in the present specification and the accompanying drawings, and may be variously modified by those skilled in the art without departing from the spirit and scope of the present disclosure.

What is claimed is:

1. A battery apparatus for a vehicle, comprising:
a basic battery pack mounted within the vehicle;
an auxiliary battery pack selectively mountable within the vehicle, wherein the auxiliary battery pack is connected in series with or in parallel to the basic battery pack; and
a cooling line through which a cooling fluid is circulated is connected to each of the basic battery pack and the auxiliary battery pack.

2. The battery apparatus according to claim 1, wherein each of the basic battery pack and the auxiliary battery pack includes a plurality of cells, and the basic battery pack includes a battery management unit configured to monitor and manage the basic battery pack and the auxiliary battery pack.

3. The battery apparatus according to claim 1, wherein each of the basic battery pack and the auxiliary battery pack includes a cell management unit configured to separately monitor and manage a plurality of cells within the battery packs.

4. A battery apparatus for a vehicle, comprising:
a basic battery pack mounted within the vehicle; and
an auxiliary battery pack selectively mountable within the vehicle, wherein the auxiliary battery pack is connected in series with the basic battery pack,
wherein each of the basic battery pack and the auxiliary battery pack includes a plurality of modules connected in series,
wherein the module includes a plurality of sub-modules connected in series, and
wherein the sub-module includes two or more cells connected in parallel.

5. The battery apparatus according to claim 4, wherein a fuse is installed between the module and the module.

6. The battery apparatus according to claim 4, wherein the auxiliary battery pack includes a safety switch.

7. The battery apparatus according to claim 4, wherein the auxiliary battery pack is connected in series with the basic battery pack via a junction box.

8. A battery apparatus for a vehicle, comprising:
a basic battery pack mounted within the vehicle;
an auxiliary battery pack selectively mountable within the vehicle and connected in parallel to the basic battery pack; and
a power relay assembly installed within the basic battery pack, having a plurality of relays, and configured to be switched to supply operation power of the basic battery pack to a load side based on the plurality of relays are operated.

9. The battery apparatus according to claim 8, further comprising:
a bi-directional power converter installed within the auxiliary battery pack and configured to balance a voltage level between the basic battery pack and the auxiliary battery pack.

10. The battery apparatus according to claim 9, wherein the basic battery pack and the auxiliary battery pack are discharged while maintaining the balancing of the voltage level therebetween using the bi-directional power converter.

11. The battery apparatus according to claim 8, further comprising:
an auxiliary power relay assembly installed in the auxiliary battery pack and including one or more auxiliary relays.

12. The battery apparatus according to claim 11, wherein the auxiliary relay is a latch relay.

13. The battery apparatus according to claim 8, further comprising:
an auxiliary power relay assembly installed within the auxiliary battery pack, having a plurality of auxiliary relays, and configured to be switched to supply operation power of the auxiliary battery pack to the load side based on the plurality of relays are operated,
wherein the relays of the power relay assembly and the auxiliary relays of the auxiliary power relay assembly are separately connected via connection lines.
